(19) United States
(12) Patent Application Publication
(10) Pub. No.: US 2003/0047946 A1
(43) Pub. Date: Mar. 13, 2003

(54) Joint system for water well conduit assemblies

(76) Inventor: Harout Ohanesian, Laguna Niguel, CA (US)

Correspondence Address: Vic Y. Lin, MYERS DAWES & ANDRAS, Suite 1150, 19900 MacArthur Blvd., Irvine, CA, 92612, US

(21) Appl. No.: 10/196,598

(22) Filed: Jul. 16, 2002

Related U.S. Application Data
(60) Provisional application No. 60/318,167, filed on Sep. 7, 2001.

(51) Int. Cl. F16L 37/24

(52) U.S. Cl. 285/404

(57) ABSTRACT

A joint system for water well conduit assemblies includes a plurality of similar modular conduits. Each conduit comprises a cylindrical end portion at a first end and a socket at an opposite, second end configured to receive the cylindrical end portion. Matching configurations of apertures are defined in the cylindrical end portion and the socket. The cylindrical end portion of a first conduit is inserted into the socket of a second conduit. An inwardly deformable pin is inserted through each through hole defined by a pair of aligned apertures. The pin includes slots and a central axial hole with a serrated upper portion and an annular groove. A plug with a serrated head and an annular bump is disposed in the central axial hole to lock the pin in place and thus secure the conduits together. A seal is formed between the cylindrical end portion and the socket.

### RELATED APPLICATIONS

This application relates to and claims priority from U.S. Provisional Application Serial No. 60/318,167 filed on Sep. 7, 2001, entitled “WATER WELL CASING AND SCREEN JOINTING SYSTEM,” the disclosure of which is incorporated herein by reference.

### BACKGROUND OF THE INVENTION

1. Field of the Invention

The present invention relates generally to a water well joint system, more particularly, to structures and methods for coupling water well pipe assemblies.

2. Description of Prior Art and Related Information

The use of water well screen or water well casing pipes for water extraction is well known. Providing a vertical column of casing and screened pipes to form the structure of a water extraction system requires that the pipes have a threaded section at each end. Generally, one section of a pipe comprises external threads while the other end comprises internal threads adapted to mate with the external threads. Screwing the threaded sections of multiple pipes together may then form an elongated pipe assembly.

With thermoplastic pipes, it is common to cut the thread into the pipe wall, thus reducing the wall thickness of the threaded end portions. This leaves the end portions with a considerably thinner section of the original pipe thickness, thereby reducing the tensile strength factor in those areas that in turn weakens the overall column strength of the elongate assembly.

In order to avoid thinning the threaded end portions of the pipes, one approach includes using a formed thread wherein the ends of the pipe are heated and then reformed over a large spiral thread. Though this approach utilizes the full wall thickness of each pipe in the joint area, it results in a larger and more rounded nature of the thread pitch and shape. When this joint is subjected to major tensile stress, the joint sections tend to distort slightly and slip over each other, thus leading to the joint giving away.

### SUMMARY OF THE INVENTION

The present invention provides structures and methods that overcome the deficiencies of the prior art.

In one aspect, a water well joint system is provided. The system comprises a first conduit having a first aperture, a first end portion, and a second conduit having a second aperture and a socket sized to receive and overlap the first end portion. The second conduit is coupled to the first conduit with the socket receiving the first end portion such that the first aperture is aligned with the second aperture to define a through hole. A pin is disposed in the through hole. The pin comprises a central axial hole in which a stud, or plug, is disposed.

The pin comprises a pinhead and a flexible body extending from the pinhead. The pin further comprises a sloped base which may include a ratchet. The flexible body comprises slots extending from an axial hole to the outside of the flexible body. The flexible body is biased toward a conical shape.

The first end portion comprises an outer surface with an annular groove which receives an annular gasket. The socket comprises a smooth, threadless inner surface. The first conduit further comprises a cylindrical main wall with a main wall thickness. The first end portion comprises a smooth, threadless outer surface and an end portion thickness that is substantially equivalent to, or at least not less than, the main wall thickness. The second conduit comprises a cylindrical main wall with a main wall thickness. The socket comprises a socket thickness substantially equivalent to the main wall thickness.

The annular gasket comprises a plurality of alternating peaks and troughs. The gasket is configured to form a seal with the inner surface of the socket.

A modular conduit is also provided for use in connection with an elongate water well extraction assembly. The conduit comprises a main cylindrical wall having a main wall thickness, a socket defined at a first end, and a cylindrical male end portion defined at an opposite, second end which incorporates a groove containing an annular gasket. The socket defines a socket inner diameter and comprises a smooth inner socket surface. The cylindrical male end portion comprises an outer diameter substantially equivalent to the socket inner diameter and a smooth end portion outer surface incorporating a groove adapted for receiving a gasket. A first plurality of apertures are defined in the socket and disposed in a first radial configuration. A second plurality of apertures are defined in the cylindrical end portion and disposed in a second radial configuration that is substantially similar to the first radial configuration. The socket comprises a socket wall thickness not less than the main wall thickness. The cylindrical male end portion comprises an end portion wall thickness not less than the main wall thickness.

In a further aspect, a retaining mechanism, or fastener, for joining water well conduits is provided. The mechanism includes a pin comprising an annular flange, a deformable conical body extending from the annular flange, a conical body surface, a sloped base, and a central pin hole. A plug is disposed in the central pin hole. The plug comprises a stud with an annular flange with a serrated edge and an internally threaded axial hole. The sloped base of the fastener extends inwardly downward. The sloped base comprises a ratchet. The pin further comprises multiple slots cut at equal angles between each other.

A method is provided for coupling a first water well conduit to a second water well conduit. The method comprising the steps of inserting a cylindrical male end portion of a first conduit into a socket of a second conduit, aligning a first plurality of apertures of the first conduit with a second plurality of apertures of the second conduit to form a plurality of through holes, disposing a pin with a hollow core in one of the through holes, and disposing a plug into the hollow core of the pin.

The method further comprises the step of overlapping an inner surface of the cylindrical male end portion of the first conduit with a ratchet of the pin. The step of disposing a plug into the hollow core of the pin comprises inserting the plug into the hollow core of the pin. The step of inserting a cylindrical male end portion of a first conduit into a socket of a second conduit comprises the step of axially inserting the cylindrical male end portion without rotating the cylindrical male end portion with respect to the socket. The step of disposing a pin with a hollow core in one of the through holes comprises the step of deforming a portion of the pin.

In a further aspect, a water well joint system comprises a first conduit, a second conduit, and a pin. The first conduit has a first aperture, a gasket and a first end portion. The first end portion comprises an outer surface which incorporates a groove containing a gasket. The second conduit has a second aperture and a socket sized to receive and overlap the first end portion. The socket comprises a smooth inner surface. The second conduit is coupled to the first conduit with the socket receiving the first end portion such that the first aperture is aligned with the second aperture to define a through hole. The smooth outer surface incorporating the groove and the gasket of the first end portion abuts and seals with the smooth inner surface of the socket. A pin disposed in the through hole. The pin comprises an axial hole. The system further comprises a plug disposed in the axial hole of the pin.

In summary, a joint system for water well conduit assemblies includes a plurality of similar modular conduits. Each conduit comprises a cylindrical end portion at a first end and a socket at an opposite, second end configured to receive the cylindrical end portion. Matching configurations of apertures are defined in the cylindrical end portion and the socket. The cylindrical end portion of a first conduit is inserted into the socket of a second conduit. An inwardly deformable pin is inserted through each through hole defined by a pair of aligned apertures. The pin includes slots and a central axial hole with a serrated upper portion and an annular groove. A plug with a serrated head and an annular bump is disposed in the central axial hole to lock the pin in place and thus secure the conduits together. A seal is formed between the cylindrical end portion and the socket.

The invention, now having been briefly summarized, may be better understood and appreciated with a description of preferred embodiments of the concept and reference to the associated drawings.

### BRIEF DESCRIPTION OF THE DRAWINGS

FIG. 1A is a partially exploded, axial, cross-sectional view of a preferred embodiment of a joint system for a water well pipe assembly;

FIG. 1B is a transverse cross-sectional view of the preferred embodiment of the joint system;

FIG. 1C is an axial cross-sectional view of a preferred conduit socket or female end according to the invention;

FIG. 1D is an axial cross-section view of a preferred conduit spigot or male end according to the invention;

FIG. 2 is a close-up, exploded view of the area marked ‘A’ on FIG. 1A;

FIG. 3 is an exploded, perspective view of a preferred pin;

FIG. 4A is a side elevation view of the preferred pin;

FIG. 4B is a bottom plan view of the preferred pin;

FIG. 5A is an axial, cross-sectional view of the preferred stud;

FIG. 5B is a top plan view of a preferred stud;

FIG. 6 is a close-up, cross-sectional view of the area marked ‘B’ in FIG. 1A;

FIG. 7A is a cross-sectional view of the preferred gasket;

FIG. 7B is an enlarged view of the area marked ‘7B’ in FIG. 7A;

FIG. 8A is a perspective view of a preferred extractor;

FIG. 8B is a cross-sectional view taken along lines 8B-8B of FIG. 8A; and

FIG. 8C is a top plan view of the preferred extractor.

### DETAILED DESCRIPTION OF THE PREFERRED EMBODIMENTS AND BEST MODE OF THE INVENTION

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

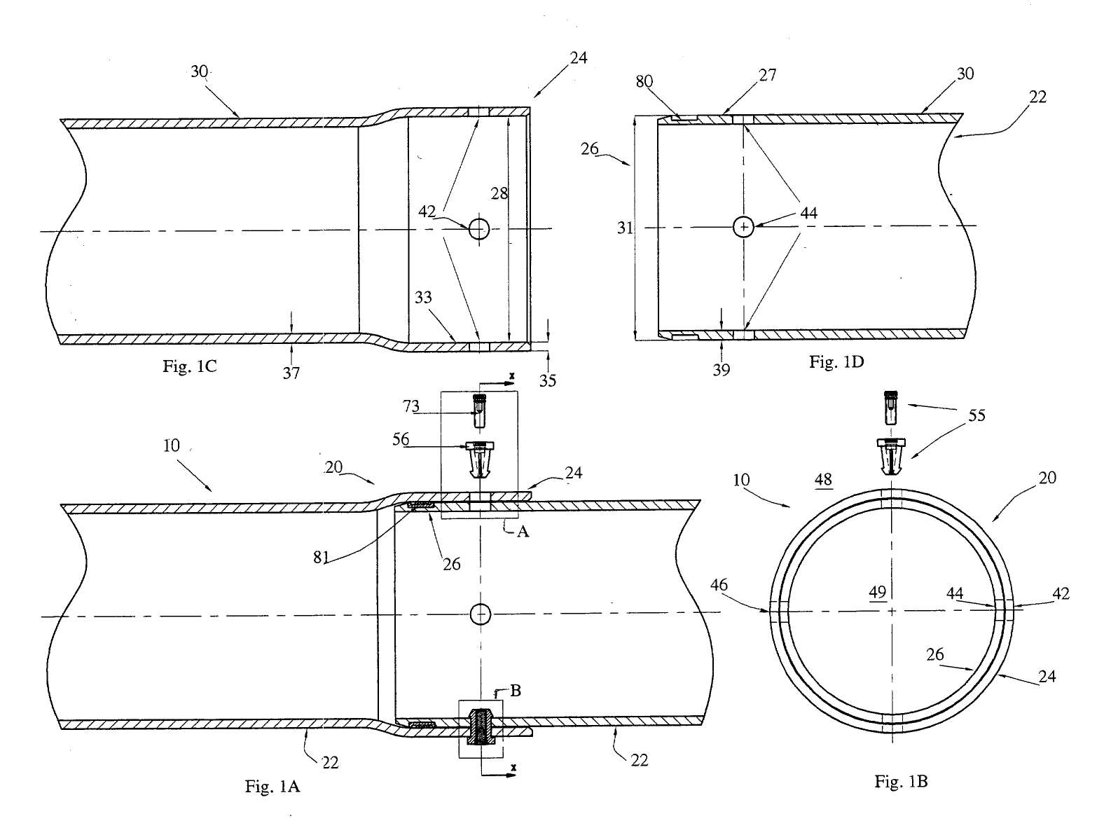

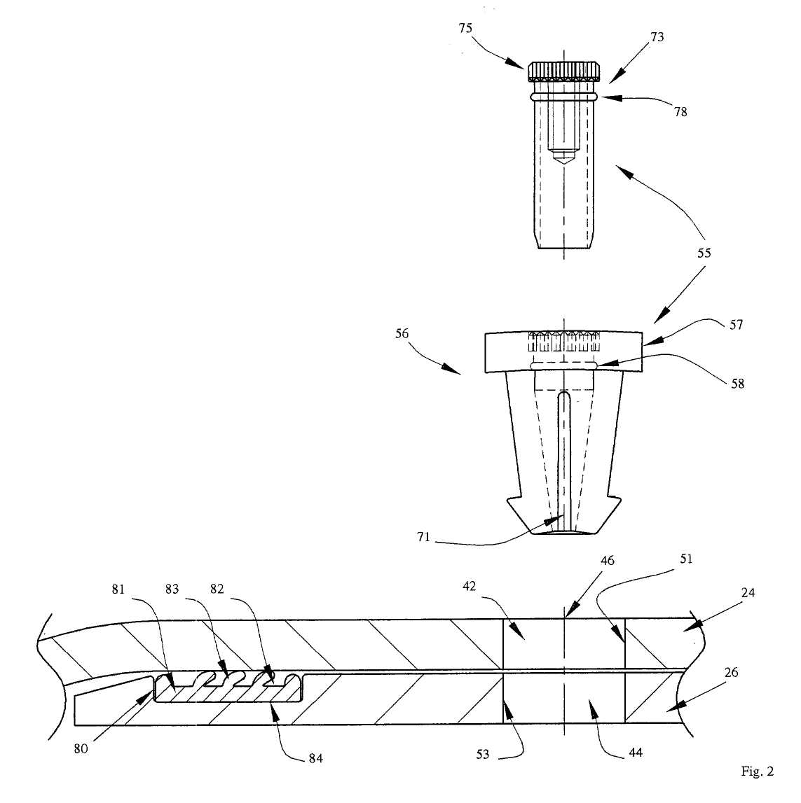

FIGS. 1A-B illustrate a water well extraction system 10 in part. The extraction system 10 may comprise a plurality of conduits, such as screens or pipes, coupled end to end to form an elongated assembly for extracting water from water wells. The extraction system 10 may included slotted pipes, granules and various other mechanisms for filtering out particulates from the liquid, such as those shown in U.S. Pat. No. 6,202,751, the disclosure of which is incorporated herein by reference.

In particular, a joint system according to the invention is illustrated in FIGS. 1A-1B and designated generally by the reference numeral 20. The joint system 20 employs a plurality of modular conduits 22 according to the invention. A preferred embodiment of the modular conduit 22 includes a first, female end portion 24 comprising a socket 24, as shown in FIG. 1C, and a second, cylindrical male end portion 26 at an opposite end, shown in FIG. 1D, configured to fit snugly within the socket 24. A main cylindrical body 30 extends between the socket 24 and the male end portion 26. In particular, the cylindrical socket 24 includes an inner diameter 28 that is roughly equivalent to, and slightly greater than, the outer diameter 31 of the male end portion 26. In the preferred embodiment, the outer diameter 31 of the cylindrical male end portion 26 is uniform with the diameter of the main cylindrical body 30. It is to be expressly understood, however, that the outer diameter 31 of the cylindrical male end portion 26 may differ from that of the main cylindrical body 30 so long as it conforms to the inner diameter 28 of the socket 24.

The socket 24 includes a smooth inner surface 33 which omits threads while the male end portion 26 comprises a smooth outer surface 27 which also omits threads. The threadless socket 24 has a socket wall thickness 35 that is preferably not less than the main wall thickness 37 of the main cylindrical body 30. Similarly, the threadless male end portion 26 comprises an end portion wall thickness 39 that is not less than the main wall thickness 37. In the preferred embodiment, both the socket wall thickness 35 and the end portion wall thickness 39 are substantially equivalent to the main wall thickness 37. By having substantially the same thickness as the main wall thickness 37, the end portions 24, 26 maintain rigidity and strength. Without threads, the male end portion 26 of a first pipe may be axially inserted into the socket 24 of a second pipe without any screwing. Only minimal rotational movement is required to align apertures as discussed below.

Though the cross-sectional shape of the preferred conduit is illustrated as circular, the profiles of the end portions 24, 26 may be provided in a variety of different shapes and configurations so long as the outer perimeter of the male end portion 26 conforms to the inner perimeter of the socket 24. The socket 24 is thus configured to receive and overlap the male end portion 26 to form a lap joint. The pipe 22 is preferably composed of a thermoplastic material, such as unplasticized polyvinylchloride (uPVC). As an example and not by way of limitation, the pipe 22 preferably varies in length from 2.0 m to 6.0 m.

In FIG. 1C, the socket 24 comprises a first plurality of apertures 42. The socket apertures, or outer apertures, 42 are preferably disposed in a transverse array such that they lie substantially on the same cross-sectional plane. In the preferred embodiment, the radial socket apertures 42 are provided as oppositely disposed pairs. The male end portion 26 also comprises a second plurality of inner apertures 44 disposed radially and oppositely so as to align with the first plurality of apertures 42 when the two end portions 24, 26 of adjacent pipes 22 are coupled, as shown in FIG. 1B. In FIG. 1B, the socket 24 of a first pipe 22 receives and overlaps the conforming, male end portion 26 of a second, substantially similar pipe 22.

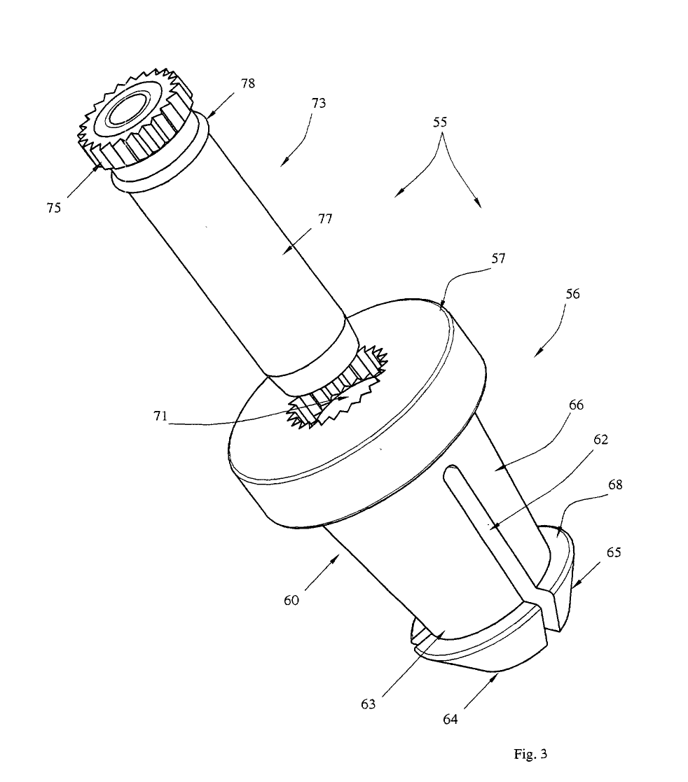

The first plurality of socket apertures 42 are configured to match the second plurality of inner apertures 44 of the male end portion 26. By rotating one conduit 22 with respect to the other 22, the apertures 42, 44 may be easily aligned as shown in FIG. 1B. Once aligned, each outer aperture 42 and corresponding inner aperture 44 collectively define a through hole 46 that is open to both the exterior 48 and the interior 49 of the joint system 20. The outer aperture 42 and inner aperture 44 are further defined by internal surfaces 51, 53, respectively, as shown in FIG. 2. The apertures 42, 44 share a substantially similar diameter such that the through hole 46 maintains a uniform diameter throughout its length.

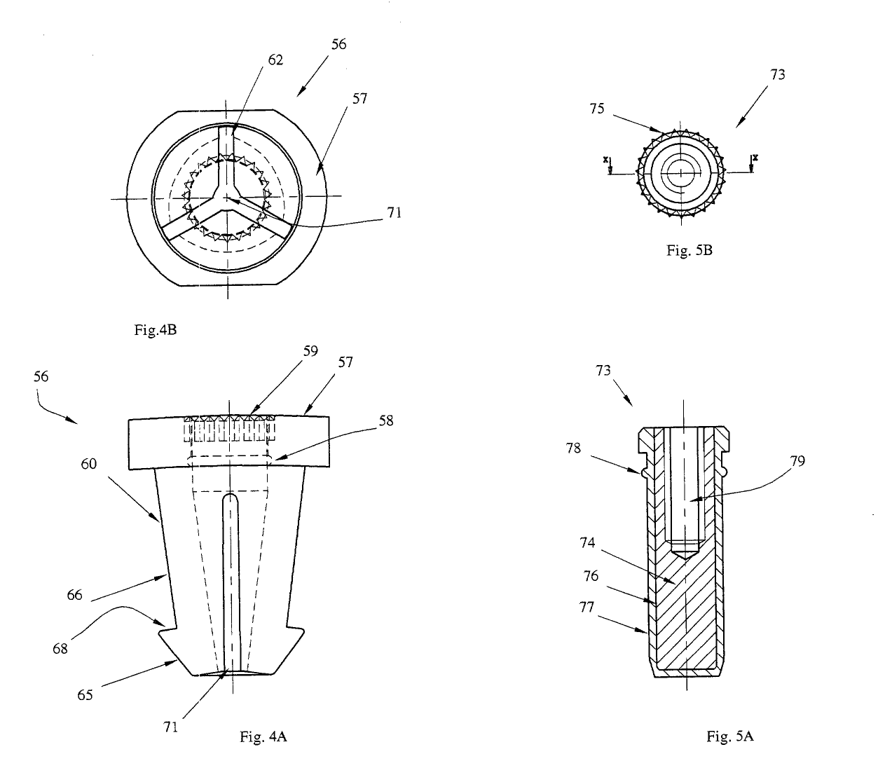

In FIG. 2, each through hole 46 is sized and shaped to receive a fastener 55 according to the invention. FIG. 3 is an exploded view of a first preferred embodiment of a fastener 55. The fastener 55 comprises a locating pin 56 and a plug, or stud, 73. In FIGS. 3, 4A and 4B, the pin 56 includes a pinhead 57 preferably shaped as an annular flange. The locating pin 56 is preferably composed of a polyamide, glass filled polyamide or fiber filled polyamide reinforced material. A compressible, or deformable, body 60 extends from the pinhead 57 to the pin base 64. The pinhead 57 includes an internally knurled bore 59 that defines an upper portion of an axial hole 71.

The flexible body 60 is biased toward a conical shape and compressible by virtue of axial slots 62 and the centralized hole 71 defined axially through the body 60. The slots 62 are preferably set at equal angles to each other, thus dividing the conical body 60 into multiple, substantially similar parts 63. Each slot 62 extends radially from the hole 71 to the outer surface 66. The conical body 60 includes an outer surface 66 extending between the head 57 and the base 64. The base 64 includes a beveled circular edge 65 that protrudes outwardly from the main surface 66 and then slopes inwardly as it extends away from the head 57. The base 64 thus includes a lip, or ratchet, 68.

The centralized, axial hole, or hollow core, 71 is biased toward a conical shape by virtue of the conically biased body 60. Extending through the entire length of the pin 56, the hole 71 is adapted to receive the stud 73. Thus, the hole 71 includes a transverse groove 58 situated within the body section of the head 57, and a serrated entry section 59, both of which are configured to receive corresponding portions of the stud 73. Alternatively stated, the pin 56 defines a serrated entry section 59 and a lower, annular recess 58 that conforms to the serrated flange 75 and annular bump 78, respectively, of the stud 73.

In FIGS. 5A and 5B, the stud 73 comprises a cylinder 74 preferably composed of metal, and an outer casing 77 preferably composed of plastic. The cylinder 74 is preferably composed of stainless steel or other type of metal which will not corrode in contact with water. The cylinder 74 has a roughened, splined or knurled surface 76 which facilitates securing of the plastic covering onto the cylinder 74 without becoming detached under stress. The stud 73 includes a top splined, or knurled, flange 75 and a lower annular protrusion, or bump, 78, both of which are preferably formed as integral parts of the plastic covering 77. The cylinder 74 includes an internally threaded hole 79.

Referring to FIG. 2, the pin 56 is first inserted in the through hole 46 in a preferred method of assembly. It will be appreciated that the conically biased body 60 facilitates easy insertion. The sloping edge 65 at the end of the pin 56 helps to centrally locate the pin 56 during insertion into the hole 46. The stud 73 is then inserted into the axial hole 71 of the pin 56.

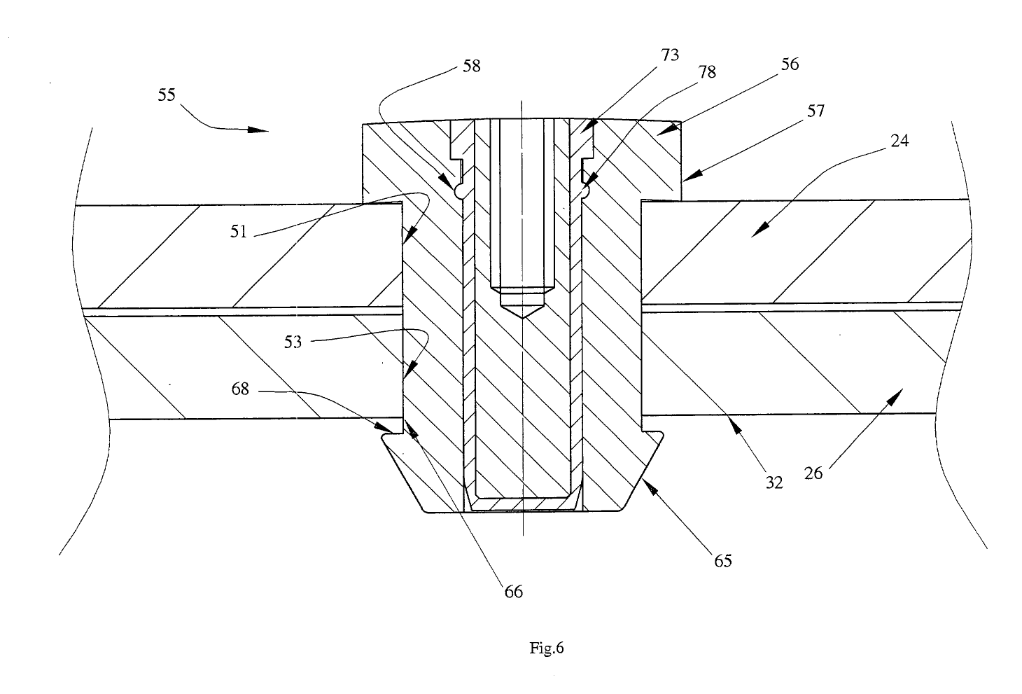

In FIG. 6, a self-locking fit is facilitated as the annular flange 57 rests upon the outer surface of the socket 24. As the stud 73 is inserted into the axial hole 71, the pin sections 63 are forced outward, opening the pin 56. The annular protrusion 78 of the stud 73 fits into the groove 58 of the hole 71 while the externally knurled flange 75 fits in the internally knurled bore 59, thereby locking the stud 73 in position within the pin 56. As a result, the outer pin surface 66 is abutted against the through hole inner surfaces 51, 53 of the apertures 42, 43, respectively. The ratchet lip 68 is expanded, and thus activated, to prevent retraction of the pin 56. In particular, the insertion of the stud 73 extends the ratchet lip 68 such that it is locked against the inner surface 32 of the male end portion 26. This action fully locates and securely locks the fastener 55 into position, which in turn secures the socket 24 to the male end portion 26.

It will be appreciated that the externally knurled flange 75 and the internally knurled bore 59 serve to rotationally fix the stud 73 to the pin 56 such that one may not rotate with respect to the other. Accordingly, the annular protrusion 78 and the annular recess 58 serve to axially fix the stud 73 to the pin 56 so as to limit incidental axial movement of one with respect to the other. The annular bump 78 and annular recess 58 are thus configured to form a fit secure enough such that the stud 73 will not axially retract from the pin 56 of its own volition, yet loose enough such that the stud 73 may be withdrawn from the pin 56 by external force.

Each pin 56 and corresponding stud 73 collectively form the fastener 55. Thus, a fastener 55 may be provided for each through hole 46 to form an extremely strong connection and ultimately a strong elongated column of multiple pipes. It will be appreciated that tensile strength is not compromised because the thicknesses of the end portions 24, 26 have not been thinned as is common with threaded end portions in the prior art. By obviating the need for threads, the end portions 24, 26 may maintain the same thickness as the remainder of the conduit 22. Furthermore, a more reliable connection is made as compared to the rounded, spiraled threads which tend to slip.

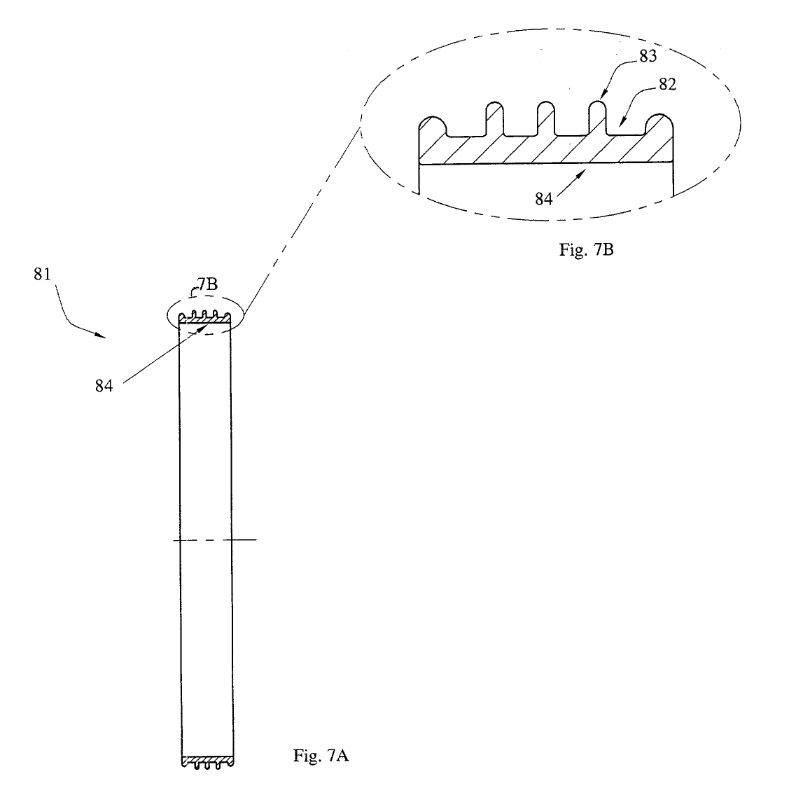

In FIGS. 1A, 1D and 2, the male end portion 26 includes a transverse, annular groove 80 adapted for receiving an annular gasket 81. The gasket 81 may be composed of EPDM, rubber or any other flexible material capable of forming a seal with a pipe or conduit joint used in the transportation of potable water. The inner surface of the gasket 81, as shown in FIGS. 7A and 7B, may be glued, bonded or otherwise affixed to the bottom of the groove 80, providing a snug fit. The outer portion of the gasket 81 comprises of a plurality of alternating peaks 83 and troughs 82. The height of the peaks 83 is configured such that when the joint system 20 is assembled, the peaks 83 are deformed in such a manner as to form a water tight seal with the socket inner surface 33. The height of the peaks 83 are also designed such that, when deformed, they do not interfere with each other, but rather deform and deflect laterally into the space created by the troughs 82. This prevents the deformable peaks 83 from interfering with each other and causing any difficulties when inserting the two end portions 24, 26 together.

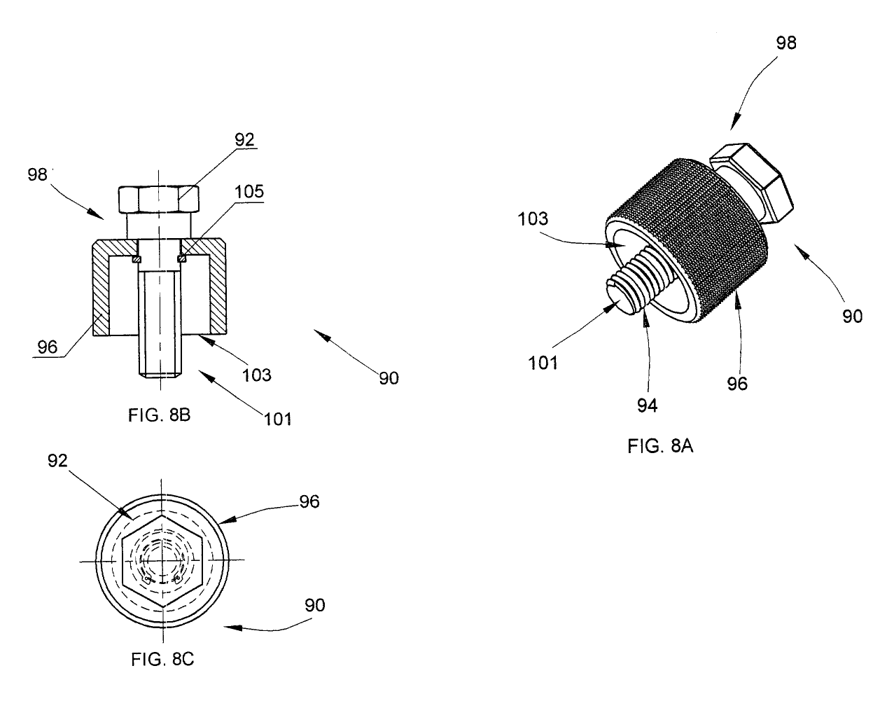

Once fully located in position, the fastener 55 will not of its own volition become loose. To disassemble the joint system 20, an externally threaded extractor 90, as shown in FIGS. 8A-8C, is provided that mates with the internally threaded hole 79 of the stud 73. In FIGS. 8A-8C, the extractor includes a bolt 92 with external threads 94. An externally knurled housing 96 extends from a top portion 98 of the bolt 92 and surrounds a portion of the bolt shaft 101. The housing 96 includes an open end 103. A circlip 105 disposed around the bolt shaft 101 couples the bolt 92 to an interior of the housing 96. To prevent the stud 73 from rotating when initially engaging the extractor 90, the serrated sections 75, 59 on the stud 73 and pin 56, respectively, hold the stud 73 in position until the extractor 90 is securely coupled to the stud 73 to enable retraction. As the stud 73 is retracted from the pin 56, the pin body sections 63 are biased back toward their original, conical shape and the ratchet lip 68 disengages from the inner surface of the end portion 26. The pins 56 may then be removed and the joint 20 disassembled.

It is to be expressly understood that the interlocking sections 75, 59 may comprise any form or shape sufficient to provide a secure fit with each other such that one may not turn with respect to the other when a rotational, or twisting, force is applied to either.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A water well joint system, the system comprising:
a first conduit having a first aperture and a first end portion;
a second conduit having a second aperture and a socket sized to receive and overlap the first end portion, the second conduit being coupled to the first conduit with the socket receiving the first end portion such that the first aperture is aligned with the second aperture to define a through hole;
a pin disposed in the through hole, the pin comprising an axial hole; and
a stud disposed in the central axial hole.

2. The system of claim 1, wherein the pin comprises a pinhead and a flexible body extending from the pinhead.

3. The system of claim 2, wherein the flexible body comprises a series of slots extending from the axial hole in the body to an outer surface of the body.

4. The system of claim 2, wherein the flexible body is biased toward a conical shape.

5. The system of claim 1, wherein the pin comprises a sloped base.

6. The system of claim 4, wherein the sloped base comprises a ratchet.

7. The system of claim 1, wherein the first end portion comprises a smooth outer surface.

8. The system of claim 1, wherein the socket comprises a smooth inner surface.

9. The system of claim 1, wherein:
the first conduit further comprises a cylindrical main wall with a main wall thickness; and
the first end portion comprises an end portion thickness substantially equivalent to the main wall thickness.

10. The system of claim 1, wherein:
the second conduit comprises a cylindrical main wall with a main wall thickness; and
the socket comprises a socket thickness substantially equivalent to the main wall thickness.

11 The system in claim 1, wherein the first end portion comprises a groove, the system further comprising an annular gasket disposed in the groove and configured to form a seal with the socket.

12. The system in claim 11, wherein the gasket comprises a plurality of peaks and troughs.

13. The system in claim 1, wherein:
the stud comprises an externally knurled surface; and
the pin comprises an internally knurled surface that conforms to the externally knurled surface of the stud.

14. The system in claim 1, wherein:
the stud comprises an annular protrusion; and
the pin comprises an annular recess adapted to receive the annular protrusion.

15. A modular conduit for use in connection with an elongate water well extraction assembly, the conduit comprising:
a main cylindrical wall having a main wall thickness;
a socket defined at a first end, the socket defining a socket inner diameter and comprising a smooth inner socket surface;
a cylindrical end portion defined at an opposite, second end, the cylindrical end portion comprising an outer diameter substantially equivalent to the socket inner diameter and a smooth end portion outer surface;
a first plurality of apertures defined in the socket and disposed in a first radial configuration;
a second plurality of apertures defined in the cylindrical end portion and disposed in a second radial configuration that is substantially similar to the first radial configuration;
a groove defined in the cylindrical end portion; and
a sealing gasket disposed in the groove.

16. The conduit of claim 15, wherein the socket comprises a socket wall thickness not less than the main wall thickness.

17. The conduit of claim 15, wherein the cylindrical end portion comprises an end portion wall thickness not less than the main wall thickness.

18. A fastener for joining water well conduits, the mechanism comprising:
a pin comprising an annular flange, a deformable conical body extending from the annular flange, a conical body surface, a sloped base with a ratcheted lip, and a central pin hole; and
a plug disposed in the central pin hole.

19. The fastener of claim 18, wherein the sloped base extends inwardly downward.

20. The fastener of claim 18, wherein the plug comprises a stud.

21. The fastener of claim 18, wherein the sloped base comprises a ratchet.

22. The fastener of claim 18, wherein the pin further comprises a plurality of slots open to the central pin hole.

23. The fastener of claim 18, wherein:
the pinhead defines an internally knurled bore that forms an upper portion of the central pin hole; and
the plug comprises an externally knurled portion that mates with the internally knurled bore.

24. The fastener of claim 23, wherein the plug comprises an annular bump; and
the pin comprises an annular recess configured to receive the annular bump.

25. The fastener of claim 18, wherein the pin comprises a cylinder and an outer plastic coating.

26. The fastener of claim 18, wherein the cylinder comprises an internally threaded hole.

27. A method for coupling a first water well conduit to a second water well conduit, the method comprising the steps of:
inserting a male end portion of a first conduit into a socket of a second conduit;
aligning a first plurality of apertures of the first conduit with a second plurality of apertures of the second conduit to form a plurality of through holes;
disposing a pin with a hollow core in one of the through holes; and
disposing a stud into the hollow core of the pin.

28. The method of claim 27, further comprising the step of overlapping an inner surface of the male end portion of the first conduit with a ratchet of the pin.

29. The method of claim 27, wherein the step of disposing a plug into the hollow core of the pin comprises the step of activating a ratchet of the pin.

30. The method of claim 27, wherein the step of inserting a male end portion of a first conduit into a socket of a second conduit comprises the step of axially inserting the male end portion without rotating the male end portion with respect to the socket.

31. The method of claim 27, wherein the step of disposing a pin with a hollow core in one of the through holes comprises the step of deforming a portion of the pin.

32. The method of claim 27, further comprising forming a seal between an outer surface of the male end portion and an inner surface of the socket.

33. A water well joint system comprising:
a first conduit having a first aperture and a first end portion, the first end portion comprising a smooth outer surface;
a second conduit having a second aperture and a socket sized to receive and overlap the first end portion, the socket comprising a smooth inner surface, the second conduit being coupled to the first conduit with the socket receiving the first end portion such that the first aperture is aligned with the second aperture to define a through hole, the smooth outer surface of the first end portion abutting the smooth inner surface of the socket; and
a pin disposed in the through hole.

34. The system of claim 33, wherein the pin comprises an axial hole.

35. The system of claim 34, further comprising a plug disposed in the axial hole of the pin.

36. A water well joint system comprising:
a first conduit having a first aperture and a first end portion, the first end portion comprising a smooth outer surface;
a second conduit having a second aperture and a socket sized to receive and overlap the first end portion, the socket comprising a smooth inner surface, the second conduit being coupled to the first conduit with the socket receiving the first end portion such that the first aperture is aligned with the second aperture to define a through hole, the smooth outer surface of the first end portion abutting the smooth inner surface of the socket;
a pin disposed in the through hole, the pin defining an axial hole;
a stud disposed in the axial hole of the pin;
means for rotationally fixing the pin to the stud; and
means for axially fixing the pin to the stud.

37. The system in claim 36, wherein the stud comprises an axial, threaded hole.

38. The system in claim 37, further comprises a threaded extractor configured to removably mate with axial, threaded hole.

39 The system in claim 36, wherein the means for rotationally fixing the pin to the stud comprises a serrated flange included in the stud and a corresponding serrated bore included in the pin.

40. The system in claim 36, wherein the means for axially fixing the pin to the stud comprises an annular bump included in the stud and a corresponding annular recess included in the axial hole of the pin.
